(19) United States
(12) Patent Application Publication
(10) Pub. No.: US 2019/0319561 A1
(43) Pub. Date: Oct. 17, 2019

(54) MOTOR CONTROLLER, SENSORLESS BRUSHLESS MOTOR, FAN, AND MOTOR CONTROL METHOD

(71) Applicant: Nidec Corporation, Kyoto (JP)

(72) Inventors: Masahiro YAMADA, Kyoto (JP); Daisuke SHIMIZU, Kyoto (JP)

(21) Appl. No.: 16/471,016

(22) PCT Filed: Dec. 28, 2017
(86) PCT No.: PCT/JP2017/047356

§ 371 Date: Jun. 19, 2019

(30) Foreign Application Priority Data
Feb. 2, 2017 (JP) 2017-017905

(51) Int. Cl. H02P 6/18; H02P 6/22

(52) U.S. Cl. CPC H02P 6/18; H02P 2006/045; H02P 6/22

(57) ABSTRACT

A motor controller includes an energization pattern determiner that determines an energization pattern that specifies a coil to be energized from coils of multiple phases and a current supply that supplies a current to the coil based on the energization pattern. The energization pattern determiner includes, assuming that an energization period is a time from determination of the energization pattern to determination of the next energization pattern, a first operation mode in which the energization period is determined based on a rotation speed of the rotor, and a second operation mode in which the energization period is longer than in the first operation mode. At the start of activation, the energization pattern determiner passes through multiple energization periods in the second operation mode, and then shifts to the first operation mode.

### CROSS REFERENCE TO RELATED APPLICATIONS

This is the U.S. national stage of PCT Application No. PCT/JP2017/047356, filed on Dec. 28, 2017, and priority under 35 U.S.C. § 119(a) and 35 U.S.C. § 365(b) is claimed from Japanese Application No. 2017-017905, filed Feb. 2, 2017; the entire disclosures of which are incorporated herein by reference.

### 1. Field of the Invention

The present disclosure relates to a control method of controlling a sensorless brushless motor and a motor controller, and also relates to a sensorless brushless motor controlled by the motor controller and a fan using the sensorless brushless motor.

### 2. Background

For example, in a structure of a conventional centrifugal brushless motor a pulse voltage is applied to a predetermined coil, and a rotor position is detected based on a voltage induced in a non-energized phase. By switching the direction of current flow of a three-phase winding based on the position information, drive control including activation in a predetermined rotational direction is performed.

However, in the structure of a conventional centrifugal brushless motor to detect the position of the rotor, when an activation command is generated, pre-activation energization control is performed to switch the energizing direction of a Y-connected sensorless three-phase brushless motor to be activated at intervals shorter than the response time of the rotor, by sequentially applying pulse currents from a U-phase winding to a V-phase winding, the V-phase winding to a W-phase winding, and the W-phase winding to the U-phase winding. The level of voltage of a non-energized phase winding of the three-phase brushless motor with respect to the midpoint voltage of the Y connection is determined during application of the pulse currents to form non-energized phase voltage information from the determination results of the energization directions. Reference voltage information that coincides with non-energized phase voltage information when an activation command is given is detected from among pieces of reference voltage information on rotor positions based on non-energized phase voltage information in multiple rotor positions of the three-phase brushless motor retained in a reference information table. The energization direction for activation of the three-phase brushless motor is determined based on the detection, and the three-phase brushless motor needs to be forcibly energized in the determined energization direction for activation. Thus, the configuration is complex.

In addition, when the pulse voltage applied to the coil is long at the start of the rotor, depending on the position of the rotor, the rotor may first rotate in a direction opposite to the desired rotation direction and then rotate in the desired rotation direction. Such reverse rotation may cause vibration of the motor.

### SUMMARY

An example embodiment of the preset disclosure provides a motor controller that controls rotation of a sensorless brushless motor including a rotor that includes a magnet including magnetic poles and a stator that includes coils of multiple phases. The motor controller includes an energization pattern determiner that determines an energization pattern that specifies a coil to be energized from the coils of multiple phases, and a current supply that supplies a current to the coil based on the energization pattern. The energization pattern determiner includes, assuming that an energization period is a time from determination of the energization pattern to determination of the next energization pattern, a first operation mode in which the energization period is determined based on a rotation speed of the rotor, and a second operation mode in which the energization period is longer than in the first operation mode. At the start of activation of the sensorless brushless motor, the energization pattern determiner passes through multiple energization periods in the second operation mode, and then shifts to the first operation mode.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a cross-sectional view of an example embodiment of a brushless motor of the present disclosure.

FIG. 2 is a schematic view of the brushless motor shown in FIG. 1.

FIG. 3 is a block diagram showing an electrically connected state of the brushless motor.

FIG. 4 is a diagram showing input signals and energization patterns of a switching circuit in a first operation mode.

FIG. 5 is a diagram showing the brushless motor stopped in a first stop position.

FIG. 6 is a diagram showing the brushless motor stopped in a second stop position.

FIG. 7 is a diagram showing the brushless motor stopped in a third stop position.

FIG. 8 is a diagram showing the brushless motor stopped in a fourth stop position.

FIG. 9 is a diagram showing the brushless motor stopped in a fifth stop position.

FIG. 10 is a diagram showing the brushless motor stopped in a sixth stop position.

FIG. 11 is a diagram showing input signals and energization patterns of the switching circuit in a second operation mode.

FIG. 12 is a timing chart showing activation of a brushless motor of an example embodiment of the present disclosure.

FIG. 13 is a diagram showing a waveform of an input current controlled by a current controller of a motor drive unit of an example embodiment of the present disclosure.

FIG. 14 is a timing chart showing currents flowing through coils and the torque acting on a rotor when operating at the input voltage shown in FIG. 13.

FIG. 15 is an enlarged cross-sectional view of a portion of an example of a fan according to an example embodiment of the present disclosure.

### DETAILED DESCRIPTION

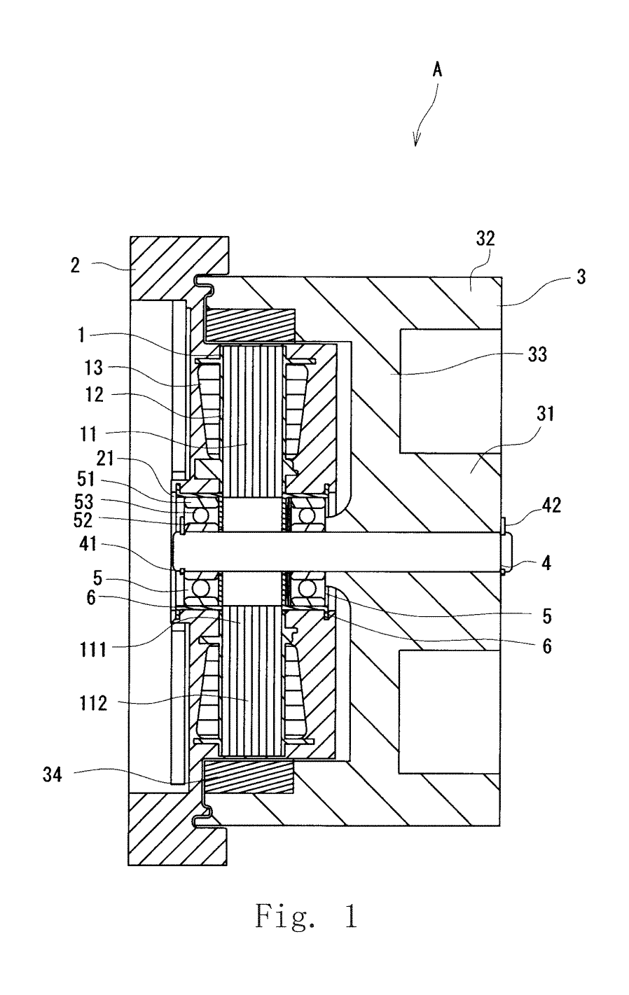

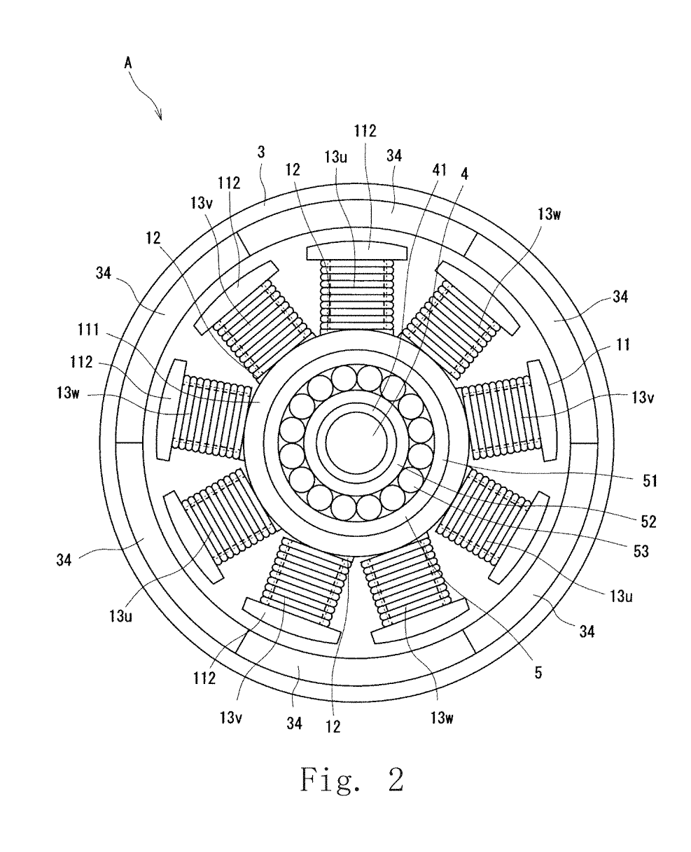

Hereinafter, example embodiments of the present disclosure will be described with reference to the drawings. FIG. 1 is a cross-sectional view of an example of a brushless motor of the present disclosure. FIG. 2 is a schematic view of the brushless motor shown in FIG. 1. Note that in the following description, it is assumed that the center of a shaft is the central axis, and the shaft rotates about the central axis. The description will be given on the assumption that a direction extending along the central axis is the axial direction, a direction orthogonal to the central axis is the radial direction, and the circumferential direction of a circle centered on the central axis is the circumferential direction. Further, as for the rotation direction of a rotor, the clockwise direction (CW direction) and the counterclockwise direction (CCW direction) are defined based on the brushless motor shown in FIG. 2 as viewed from the upper side of the brushless motor.

As shown in FIG. 1, a brushless motor A of the example embodiment includes a stator 1, a casing 2, a rotor 3, a shaft 4, a bearing 5, and a bearing storage member 6. The stator 1 is covered with the casing 2. The shaft 4 is attached to the rotor 3. Then, the shaft 4 is supported by the casing 2 through the two bearings 5. The rotor 3 includes an annular magnet 34, and is disposed outside the stator 1. That is, the brushless motor A of the example embodiment is an outer rotor type DC brushless motor in which the rotor 3 is attached to the outside of the stator 1. While the outer rotor type DC brushless motor is exemplified in the example embodiment, the present disclosure is also applicable to an inner rotor type DC brushless motor.

The stator 1 has a stator core 11, an insulator 12, and a coil 13. The stator core 11 is configured such that multiple steel plates (electromagnetic steel plates) are stacked on top of one another in the axial direction. That is, the stator core 11 is electrically conductive. Note that the stator core 11 is not limited to the structure in which electromagnetic steel plates are stacked on top of one another, and may be a single member. The stator core 11 includes a core back 111 and teeth 112. The core back 111 has in an axially extending cylindrical shape. The teeth 112 protrude radially outward from an outer peripheral surface of the core back 111. As shown in FIG. 2, the stator core 11 includes nine teeth 112. The teeth 112 are arranged at equal intervals in the circumferential direction. That is, in the brushless motor A of the example embodiment, the stator 1 has nine slots.

The insulator 12 covers the teeth 112. The insulator 12 is a resin molded body. The coil 13 is configured such that a conductor wire is wound around the teeth 112 covered with the insulator 12. The insulator 12 insulates the teeth 112, that is, the stator core 11 and the coil 13. Note that while the insulator 12 is a resin molded body in the example embodiment, the disclosure is not limited to this. A wide variety of configurations that can insulate the stator core 11 and the coil 13 may be adopted.

As described above, the insulator 12 insulates the stator core 11 and the coil 13. Accordingly, in the stator core 11, an exposed portion not covered with the insulator 12 is formed around the core back 111.

The nine coils 13 included in the stator 1 are divided into three groups (hereinafter referred to as three phases) which differ in timing of supply of an electric current. The three phases are defined as a U phase, a V phase, and a W phase. That is, the stator 1 includes three U-phase coils 13u, three V-phase coils 13v, and three W-phase coils 13w. As shown in FIG. 2, the U-phase coil 13u, the V-phase coil 13v, and the W-phase coil 13w are arranged in this order in the counterclockwise direction. That is, the V-phase coil 13v is arranged next to the U-phase coil 13u in the counterclockwise direction. Further, the W-phase coil 13w is disposed next to the V-phase coil 13v in the counterclockwise direction. Further, the U-phase coil 13u is disposed next to the W-phase coil 13w in the counterclockwise direction. Note that in the following description, when the three phases do not need to be described separately, the coils of the phases are collectively referred to as the coil 13.

The casing 2 is made of resin, and covers the stator 1 while leaving at least the exposed portion exposed. The casing 2 is a resin molded body. That is, the casing 2 prevents water from wetting the electrical wiring such as the coil 13. The casing 2 is also a case of the brushless motor A. Hence, the casing 2 may be used to fix the device in which the brushless motor A is used, to a frame or the like. For this reason, a resin strong enough to hold the brushless motor A is used to mold the casing 2. The casing 2 is not limited to a molded body, and the stator 1 may be disposed on a resin or metal base member. That is, the stator 1 may be in a non-molded state.

An opening 21 is provided in the central portion at both axial ends of the casing 2. The exposed portion of the core back 111 of the stator 1 is exposed to the outside by the opening 21. The bearing 5 accommodated in the bearing storage member 6 is attached to the opening 21.

As shown in FIG. 2, the bearing 5 is a ball bearing including an outer ring 51, an inner ring 52, and multiple balls 53. The outer ring 51 of the bearing 5 is fixed to an inner surface of the bearing storage member 6. In addition, the inner ring 52 is fixed to the shaft 4.

One end face of the bearing 5 is in contact with the bearing storage member 6. The other end face of the bearing 5 is in contact with a shaft retaining ring 41 attached to the shaft 4. This prevents the shaft 4 from coming off.

The shaft 4 has an axially extending columnar shape. In addition, the shaft 4 is fixed to the inner ring 52 of the two bearings 5 attached to the casing 2 through the bearing storage portion 6. That is, the shaft 4 is rotatably supported by the two bearings 5 at two positions separated in the axial direction.

The shaft retaining ring 41 in contact with the bearing 5 is attached to one axial end of the shaft 4. Further, a shaft retaining ring 42 in contact with the rotor 3 fixed to the shaft 4 is attached to the other axial end of the shaft 4. By attaching the shaft retaining rings 41 and 42, axial movement of the shaft 4 is suppressed. Note that while a C ring or the like may be used as the shaft retaining rings 41, 42, the disclosure is not limited to this.

As shown in FIG. 1, the rotor 3 includes an inner cylinder 31, an outer cylinder 32, a connecting portion 33, and the magnet 34. The inner cylinder 31 and the outer cylinder 32 have axially extending cylindrical shapes. The center lines of the inner cylinder 31 and the outer cylinder 32 coincide with each other. The shaft 4 is fixed to an inner peripheral surface of the inner cylinder 31. That is, the shaft 4 is fixed to the central portion of the rotor 3. One axial end of the inner cylinder 31 is in contact with the bearing 5. Further, the shaft retaining ring 42 is in contact with the other axial end of the inner cylinder 31.

The outer cylinder 32 is disposed on the outer side in the radial direction orthogonal to the axial direction of the stator 1, with a gap interposed therebetween. That is, the stator 1 holds the coils 13u, 13v and 13w of multiple phases such that the coils face the rotor 3 in the radial direction of the shaft 4. The magnet 34 is provided on an inner peripheral surface of the outer cylinder 32. The magnets 34 are arranged in the circumferential direction at positions facing the teeth 112 of the stator core 11 in the radial direction. The magnet 34 may be formed in a ring shape and have multiple magnetic poles, or may be multiple magnets with different magnetic poles. Note that in the rotor 3, six magnets 34 are arranged in the circumferential direction. Of the six magnets 34, adjacent magnets have different magnetic poles. The rotor 3 has six poles.

The connecting portion 33 connects the inner cylinder 31 and the outer cylinder 32. The connecting portion 33 extends radially outward from an outer surface of the inner cylinder 31, and is connected to an inner surface of the outer cylinder 32. Note that the connecting portion 33 may be multiple rod-like members. In addition, the connecting portion 33 may be formed in an annular plate shape continuous in the circumferential direction.

The rotor 3 is fixed to the shaft 4, and the rotor 3 and the shaft 4 rotate simultaneously. As shown in FIG. 2 and other drawings, the rotor 3 is disposed on the radially outer side of the stator 1. That is, in the brushless motor A, the rotor 3 has the shaft 4 extending along the central axis and the magnet 34 having magnetic poles. Furthermore, the brushless motor A has the stator 1 that is located in the radial direction of the shaft 4, and holds each of the coils 13 of multiple phases so that the coil 13 faces the rotor 3.

The brushless motor A has the configuration described above. The brushless motor A is a six-pole nine-slot brushless DC motor including a six-pole magnet 34 and a nine-slot stator 1. Note that the number of poles and number of slots are not limited to those described above, and may be any number of poles and number of slots forming a brushless DC motor that can be driven.

By energizing the U-phase coil 13u, the V-phase coil 13v, and the W-phase coil 13w of the brushless motor A in a predetermined order in a predetermined direction, a magnetic field is generated in each coil 13. The magnetic field generated in each coil 13u, 13v, 13w varies depending on whether electricity is supplied thereto, and the direction in which the electricity is supplied. The magnetic field generated in each coil 13u, 13v, 13w and the magnetic field of the magnet 34 attract and repel each other, thereby generating a circumferential force in the rotor 3. This causes the rotor 3 and the shaft 4 to rotate relative to the casing 2 and the stator 1.

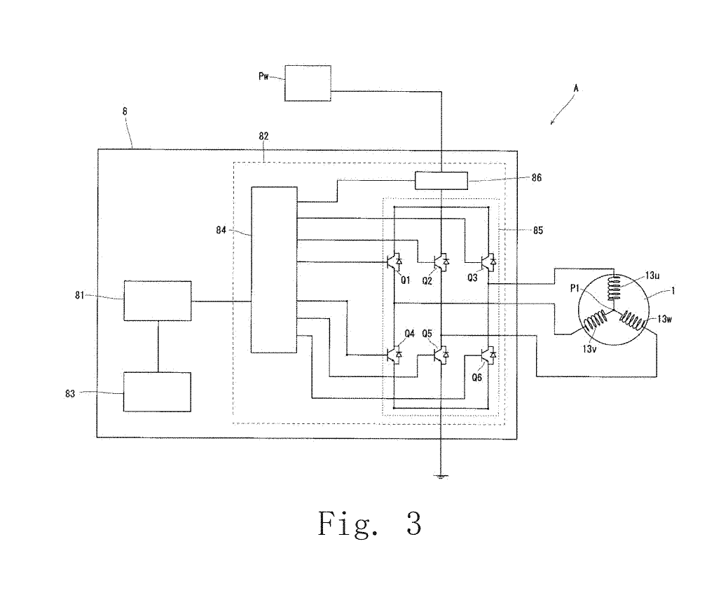

The brushless motor A is provided with a motor controller for rotating the rotor 3. Hereinafter, the motor controller will be described with reference to the drawings. FIG. 3 is a block diagram showing an electrically connected state of the brushless motor. As shown in FIG. 3, the brushless motor A is a Y connection in which the U-phase coil 13u, the V-phase coil 13v, and the W-phase coil 13w are connected at a neutral point P1. Note that while the example embodiment adopts a Y connection, a delta connection may be used instead.

The brushless motor A includes a motor controller 8 that supplies a current supplied from a power source Pw to the U-phase coil 13u, the V-phase coil 13v, and the W-phase coil 13w. The motor controller 8 includes an energization pattern determination portion 81, a current supply portion 82, and a timer 83. That is, the motor controller 8 controls rotation of the brushless motor A provided with the rotor 3 including the magnet 34 having magnetic poles and the stator 1 including the coils 13u, 13v and 13w of multiple phases.

The energization pattern determination portion 81 determines an energization pattern including information on which of the U-phase coil 13u, V-phase coil 13v, and W-phase coil 13w to supply a current, and the direction in which to supply the current. That is, the energization pattern determination portion 81 determines an energization pattern that specifies the coil to be energized from among the coils 13u, 13v, and 13w of multiple phases. The energization pattern is determined in advance, as will be described later. That is, the energization pattern determination portion 81 determines an energization pattern from among the predetermined energization patterns, and transmits the energization pattern to a controller 84 to be described later as energization pattern information. Details of the energization pattern will be described later.

The current supply portion 82 supplies a current to each of the coils 13u, 13v and 13w. The current supply portion 82 includes the controller 84, a switching circuit 85, and a current controller 86.

The switching circuit 85 is a circuit that allows a current to flow to the U-phase coil 13u, the V-phase coil 13v, and the W-phase coil 13w in a predetermined direction. The switching circuit 85 is a so-called inverter circuit including six switching elements Q1 to Q6. Note that in the following description, the switching elements Q1 to Q6 may be referred to as first to sixth switching elements Q1 to Q6. The switching elements Q1 to Q6 are elements that are turned ON or OFF based on a signal from the controller 84. While the example embodiment adopts a bipolar transistor, the disclosure is not limited to this, and an element such as an FET, a MOSFET, an IGBT, or the like that performs the same operation may be used.

As shown in FIG. 3, the emitter of the first switching element Q1 and the collector of the fourth switching element Q4 are connected. That is, the first switching element Q1 and the fourth switching element Q4 are connected in series. Similarly, the emitter of the second switching element Q2 is connected to the collector of the fifth switching element Q5, and the emitter of the third switching element Q3 is connected to the collector of the sixth switching element Q6. The collectors of the first switching element Q1, the second switching element Q2, and the third switching element Q3 are connected to each other, and are connected to the current controller 86. Further, the emitters of the fourth switching element Q4, the fifth switching element Q5, and the sixth switching element Q6 are connected to each other, and are grounded.

Then, the side opposite to the neutral point P1 of the V-phase coil 13v is connected to a connection line connecting the first switching element Q1 and the fourth switching element Q4. The side opposite to the neutral point P1 of the W-phase coil 13w is connected to a connection line connecting the second switching element Q2 and the fifth switching element Q5. Then, the side opposite to the neutral point P1 of the U-phase coil 13u is connected to a connection line connecting the third switching element Q3 and the sixth switching element Q6.

The controller 84 transmits an operation signal to the base terminal of each of the first to sixth switching elements Q1 to Q6. The switching elements Q1 to Q6 are OFF, that is, do not receive a current, when the base terminal thereof does not receive the operation signal from the controller 84 (sometimes referred to as “when the input signal is L”). In addition, the switching elements Q1 to Q6 are ON, that is, receive a current, when they receive an operation signal from the controller 84 (sometimes referred to as “when the input signal is H”).

The controller 84 determines ON or OFF of the switching elements Q1 to Q6 based on the energization pattern information sent from the energization pattern determination portion 81, and transmits an operation signal to the switching element to be turned ON. The controller 84 also controls the current controller 86. That is, the current supply portion 82 supplies a current to the coils 13u, 13v, and 13w based on the energization pattern.

The power source Pw converts alternating current into direct current and supplies it to the brushless motor A. The power source Pw includes a rectifier circuit and a smoothing circuit, which are not shown. The rectifier circuit converts alternating current into direct current using a diode bridge, for example. The smoothing circuit is a circuit that smooths fluctuations (pulsations) of a current using a resistor, a capacitor, and a coil, for example. Known circuits are used as the rectifier circuit and the smoothing circuit, and detailed descriptions thereof are omitted. The power source Pw is not limited to one that converts alternating current into direct current. The power source Pw may be a power source that supplies direct current to the brushless motor A by applying the direct current with the voltage as it is, stepping down the voltage, or stepping up the voltage.

The current controller 86 controls the current value, the supply start timing, the current waveform, and the like of the current supplied to the switching circuit 85 from the power source Pw. The controller 84 controls the current controller 86. The switching circuit 85 and the current controller 86 are controlled by the controller 84, and are in synchronization with each other. Note that while the current controller 86 is described as a circuit independent of the controller 84 in the motor controller 8 of the example embodiment, the current controller 86 may be included in the controller 84. In this case, the current controller 86 may either be provided as a part of a circuit of the controller 84, or be provided as a program that operates in the controller 84.

The timer 83 is connected to the energization pattern determination portion 81. The timer 83 measures time, and passes time information to the energization pattern determination portion 81. The energization pattern determination portion 81 determines the energization pattern based on the time information from the timer 83.

In the brushless motor A, supply of a current to the coils 13u, 13v and 13w is controlled by the motor controller 8 of the configuration. In addition, the brushless motor A described in the example embodiment is a sensorless brushless motor from which a sensor for detecting the position of the rotor 3 is omitted. In the following description, when a current flows toward the neutral point P1 from the current supply portion 82 through the coils 13u, 13v, and 13w, the side of the coils 13u, 13v, and 13w facing the rotor 3 is assumed to be the N pole.

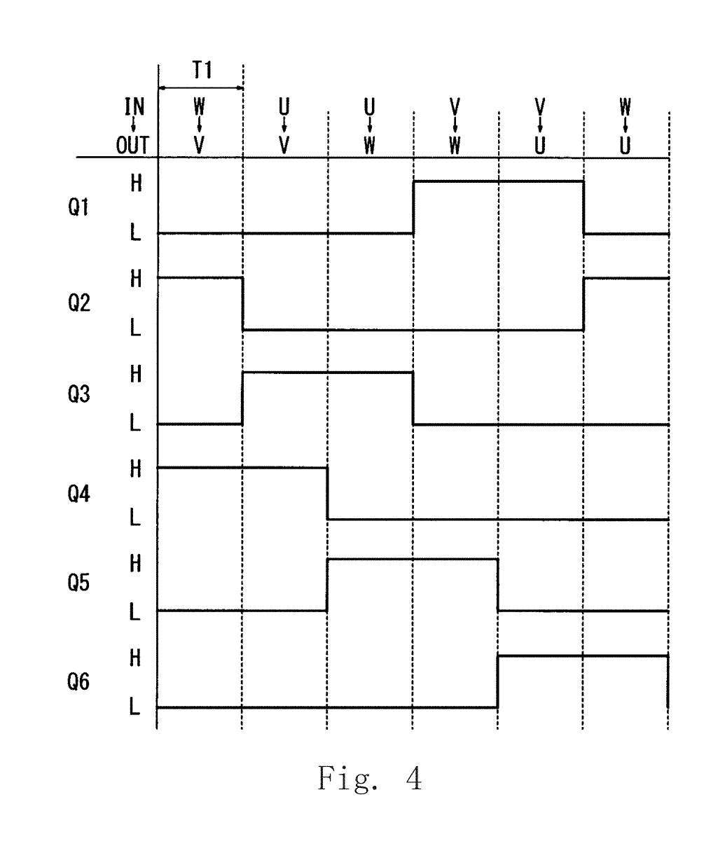

The energization pattern will be described with reference to the drawings. FIG. 4 is a diagram showing input signals and energization patterns of the switching circuit in a first operation mode. A first operation mode M1 is a mode that is executed when the rotor rotates at a constant rotation speed that is equal to or higher than a predetermined rotation speed (steady rotation). Further, in the timing chart shown in FIG. 4, the rotor 3 is rotated constantly, and this is the first operation mode. In FIG. 4, input signals to the first to sixth switching elements Q1 to Q6 are shown in this order from the top. That is, when the signal is at H, the switching element is ON.

By turning ON two switching elements other than the switching elements connected in series (Q1 and Q4, Q2 and Q5, Q3 and Q6) in the switching circuit 85, a current can be supplied to two coils from among the U-phase coil 13u, the V-phase coil 13v, and the W-phase coil 13w. For example, when the third switching element Q3 and the fourth switching element Q4 are turned ON, the current from the current controller 86 flows to the U-phase coil 13u, and to the V-phase coil 13v through the neutral point P1.

The energization pattern determined by the energization pattern determination portion 81 specifies a coil (IN coil) into which the current flows, and a coil (OUT coil) into which the current flowing through the IN coil flows via the neutral point P1. When a current flows into the U-phase coil 13u and then flows into the V-phase coil 13v, the U-phase coil 13u is the IN coil and the V-phase coil 13v is the OUT coil. The energization pattern in this case is a U-V pattern. In the case of the brushless motor A including the coils 13u, 13v, and 13w of three phases, there are six patterns which are a W-V pattern, the U-V pattern, a U-W pattern, a V-W pattern, a V-U pattern, and a W-U pattern. Note that in the brushless motor A, the energization pattern is switched in the above-mentioned order, and a current corresponding to the energization pattern is supplied to the coils 13u, 13v and 13w. This causes the rotor 3 to rotate in the counterclockwise (CCW) direction.

In the timing chart shown in FIG. 4, the horizontal axis represents time. A period when an energization pattern is selected, in other words, a time between determination of a certain energization pattern and determination of the next energization pattern, is defined as an energization period. Then, the current supply portion 82 supplies a current to the coil 13 specified by the energization pattern in the energization period. The controller 84 continuously transmits a drive signal to a switching element during the energization period. That is, the switching element turned ON by the determination of the certain energization pattern maintains the ON state during the energization period. Note that the energization period of the first operation mode M1 shown in FIG. 4 is referred to as a first energization period T1.

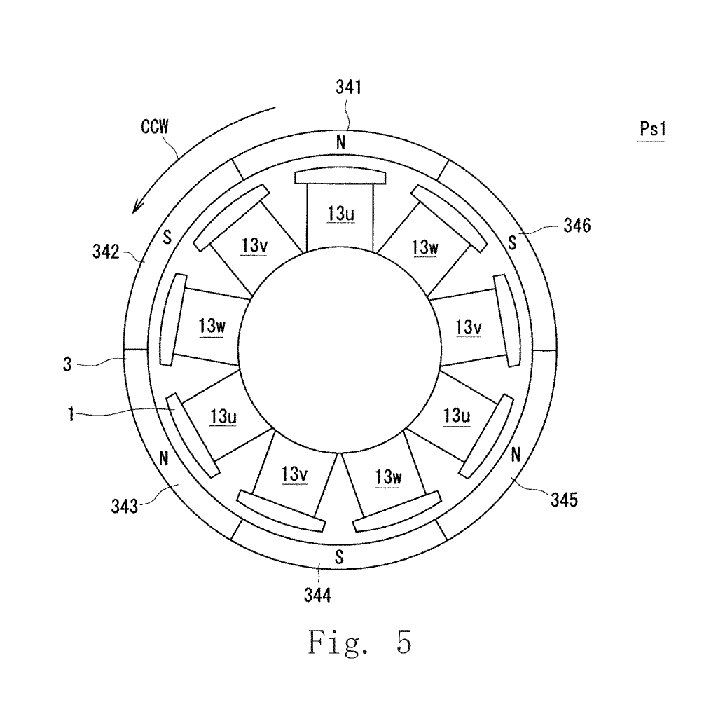

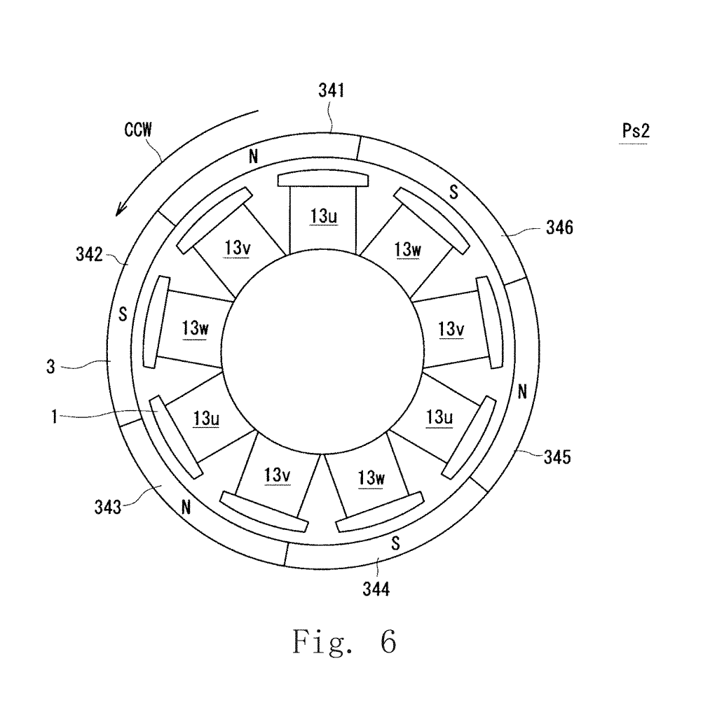

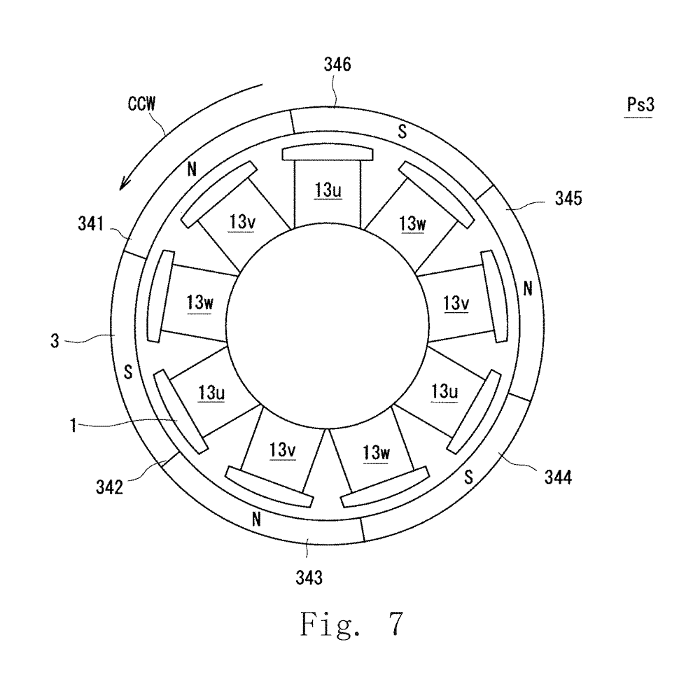

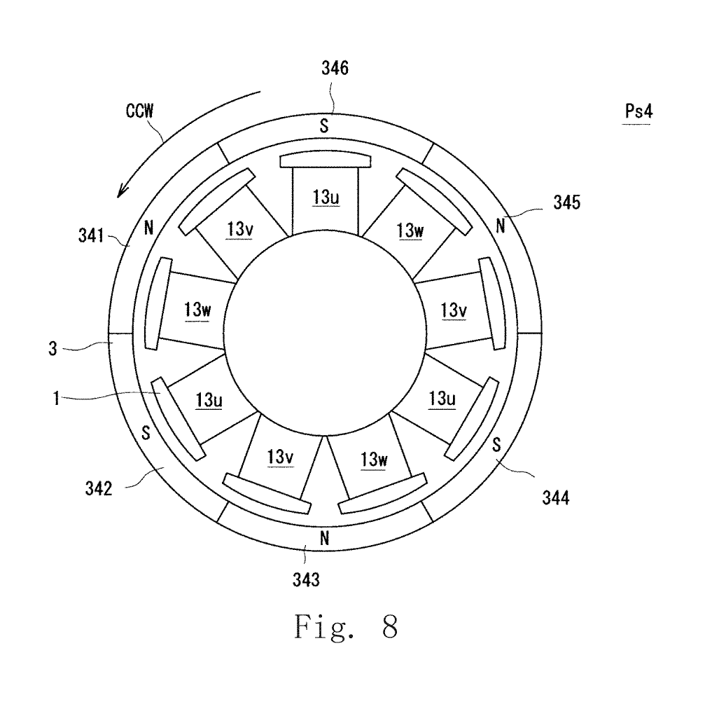

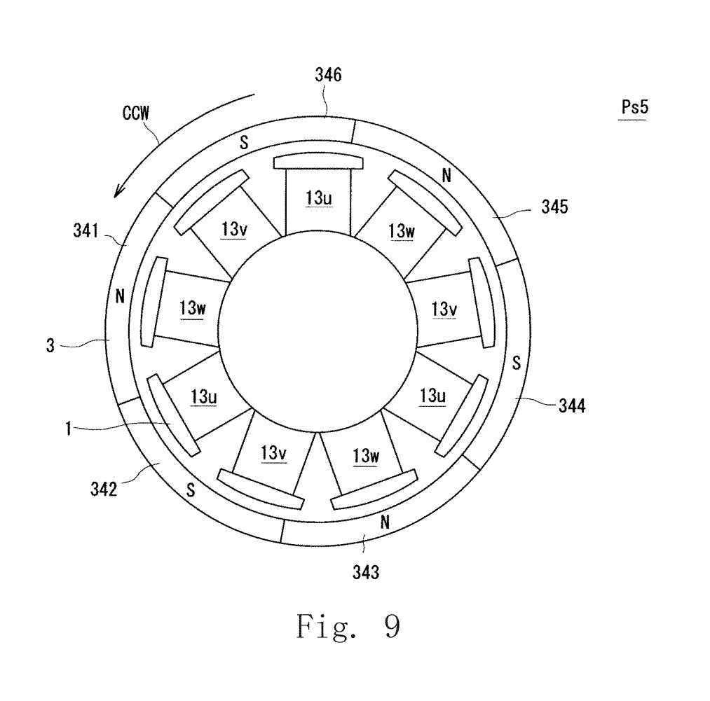

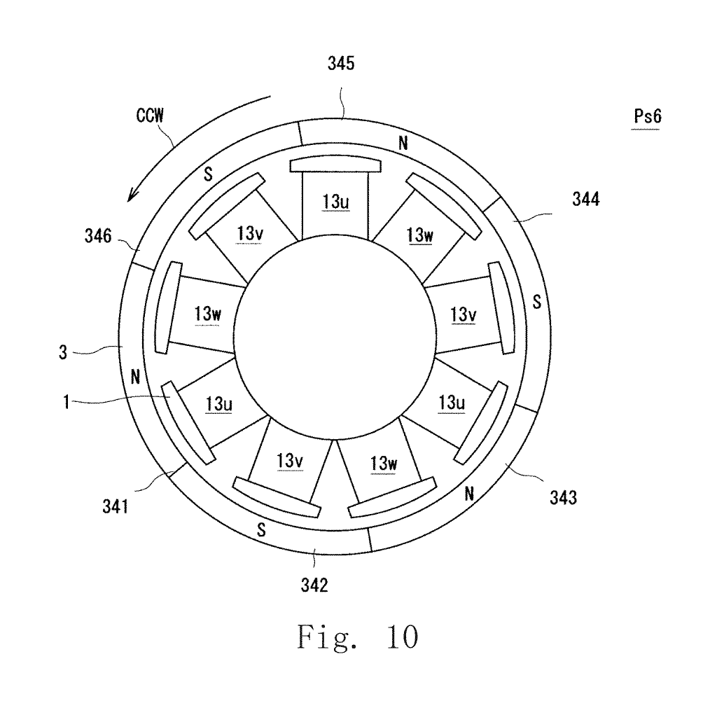

FIG. 5 is a diagram showing the brushless motor stopped in a first stop position. FIG. 6 is a diagram showing the brushless motor stopped in a second stop position. FIG. 7 is a diagram showing the brushless motor stopped in a third stop position. FIG. 8 is a diagram showing the brushless motor stopped in a fourth stop position. FIG. 9 is a diagram showing the brushless motor stopped in a fifth stop position. FIG. 10 is a diagram showing the brushless motor stopped in a sixth stop position.

While FIGS. 5 to 10 show the positional relationship between the coils 13u, 13v and 13w of the stator 1 and the magnet 34, the actual configuration includes the rotor 3, the shaft 4, and other parts. Further, the magnets 34 are distinguished as first to sixth magnets 341 to 346. In FIG. 5, the magnet located on the upper side is the first magnet 341, and the second to sixth magnets 342 to 346 are sequentially arranged in the counterclockwise direction. Furthermore, in FIGS. 5 to 10, magnetic poles (N pole or S pole) are shown on the first to sixth magnets 341 to 346 for better understanding.

The teeth 112 of the stator 1 of the brushless motor A are formed of a magnetic material such as a magnetic steel plate. When no current is supplied to the coils 13u, 13v and 13w, no magnetic flux is generated. Accordingly, in the brushless motor A, when the current supply is stopped, the teeth 112 and the magnet 34 attract each other by magnetic force regardless of the phase of the coil wound around the teeth 112. Then, when the rotation of the rotor 3 due to inertial force ends, the teeth 112 attract the magnet 34, and the attraction of the magnet 34 to the teeth 112 stops the rotor 3. The stop of the rotor 3 after stopping the supply of power is regarded as a natural stop, and the stop position is regarded as a natural stop position.

As shown in FIGS. 5 to 10, in the brushless motor A, multiple natural stop positions exist depending on the positions of the magnet 34 and the coils 13u, 13v, and 13w attached to the teeth 112. The natural stop positions of the rotor 3 shown in FIGS. 5 to 10 are natural stop positions of the six-pole nine-slot brushless motor A. The stop position of the rotor 3 changes with the number of poles and number of slots. Note that the stop positions in FIGS. 5 to 10 are referred to as first to sixth positions Psi to Ps6.

For example, the W-V pattern is determined as the energization pattern in the first position Psi. As a result, the W-phase coils 13w are excited to the N pole and the V-phase coils 13v are excited to the S pole. The first magnet 341, the third magnet 343, and the fifth magnet 345 are attracted to the V-phase coils 13v excited to the S pole. In addition, the second magnet 342, the fourth magnet 344 and the sixth magnet 346 are attracted to the W-phase coils 13w excited to the N pole. This moves the rotor 3 in the counterclockwise direction (CCW direction). The rotor 3 moves to the second position Ps2 shown in FIG. 6.

When the rotor 3 is in the second position Ps2, the energization pattern is set to the U-V pattern. As a result, the U-phase coils 13u are excited to the N pole and the V-phase coils 13v are excited to the S pole. The second magnet 342, the fourth magnet 344, and the sixth magnet 346 are attracted to the U-phase coils 13u excited to the N pole. In addition, the first magnet 341, the third magnet 343, and the fifth magnet 345 are attracted to the V-phase coils 13v excited to the S pole. This moves the rotor 3 in the counterclockwise direction (CCW direction). The rotor 3 moves to the third position Ps3 shown in FIG. 7.

Thereafter, energization by the U-W pattern moves the rotor 3 to the fourth position Ps4 shown in FIG. 8, and energization by the V-W pattern moves the rotor 3 to the fifth position Ps5 shown in FIG. 9. Then, energization by the V-U pattern moves the rotor 3 to a sixth position Ps6 shown in FIG. 10. Then, energization by the W-U pattern while the rotor 3 is in the sixth position Ps6 causes the rotor 3 to rotate by 120 degrees from the first position Psi shown in FIG. 5. Note that while the magnets 34 of the rotor 3 shown in FIGS. 5 to 10 are given individual names for convenience of explanation, the magnets 341, 343, and 345 are substantially equivalent. Likewise, the magnets 342, 344, 346 are also substantially equivalent. For this reason, the relative relationship between the magnetic pole of the magnet 34 and the phase of the coil 13 when rotated 120 degrees from the first position Psi can be regarded as substantially the same as that in the first position Psi. Hence, in the following description, the positions of the stator 1 and the magnet 34 will be described assuming that the first to sixth positions Ps1 to Ps6 are repeated.

In the brushless motor A, the rotor 3 is rotated by switching the energization pattern and supplying a current to the coils 13u, 13v, and 13w. The rotation speed of the rotor 3 can be changed by changing the first energization period T1. For example, by shortening the first energization period T1, the time before reaching the next position becomes short, that is, the rotation speed increases. Further, in the brushless motor A, the torque (force) acting on the rotor 3 changes with the supplied current.

First, the relationship between the relative position of the rotor 3 with respect to the stator 1 and the energization pattern will be described. Since the brushless motor A of the example embodiment is a sensorless type, it does not acquire the relative position of the rotor 3 with respect to the stator 1 at the time of activation. Accordingly, in the brushless motor A, the aforementioned six energization patterns are sequentially executed in an order according to the rotation direction, regardless of the relative position of the rotor 3.

In the brushless motor A, the energization pattern for generating a torque that rotates the rotor 3 in the normal direction varies depending on the position of the rotor 3 (first to sixth positions Ps1 to Ps6). That is, when the rotor 3 is stopped in the natural stop position, there are an energization pattern that can activate the rotor 3 in the normal direction, and an energization pattern that cannot activate the rotor 3 or activates the rotor 3 in the reverse direction. An operation of the rotor 3 according to the position of the rotor 3 and the energization pattern will be described. Note that the following description is given of a case where the rotor 3 is in the first position Ps1 shown in FIG. 5. Further, energization is performed until the rotor 3 stops at the natural stop position.

(1) W-V pattern

When the rotor 3 is in the first position Ps1, both the V-phase coils 13v and the W-phase coils 13w face the magnets 342, 344, 346 having the magnetic S pole. In this state, the W-phase coils 13w are excited to the N pole, and the V-phase coils 13v are excited to the S pole. As a result, the rotor 3 rotates in the normal direction to the second position Ps2 (see FIG. 6), where the magnets 341, 343, 345 having the magnetic N pole move to positions facing the V-phase coils 13v, respectively, and the magnets 342, 344, 346 having the magnetic S pole move to positions facing the W-phase coils 13w, respectively. Since the coils 13v, 13w of two phases generate a force that attracts the magnet and cause the rotor 3 to rotate normally, a torque sufficient to activate the rotor 3 can be generated. Such an energization pattern in which each of the coils of two phases can generate a force that attracts the magnet is set as an energization pattern suitable for activation in the specific position. That is, the W-V pattern is an energization pattern suitable for activation in the first position Ps1.

(2) U-V pattern

When the energization pattern determination portion 81 determines the U-V pattern as the energization pattern, the U-phase coils 13u are excited to the N pole and the V-phase coils 13v are excited to the S pole. At this time, the rotor 3 rotates in the normal direction (rotates in CCW direction) to the third position Ps3 (see FIG. 7), where the magnets 341, 343, 345 having the magnetic N pole face the V-phase coils 13v, respectively, and the magnets 342, 344, 346 having the magnetic S pole face the U-phase coils 13u, respectively.

The next U-W pattern is an energization pattern suitable for activation in the third position Ps3. Determination of the U-W pattern causes the rotor 3 to rotate in the normal direction (rotate in CCW direction) to the fourth position Ps4 (see FIG. 8).

When the energization pattern determination portion 81 starts determination from the U-V pattern, an energization pattern suitable for activation is obtained at the time of the second determination of the energization pattern. Note that in the case of the U-V pattern, the U-phase coils 13u face the centers of the magnets 341, 343, 345 having the magnetic N pole.

(3) U-W pattern

The energization pattern determination portion 81 determines the U-W pattern as the energization pattern. As a result, the U-phase coils 13u are excited to the N pole and the W-phase coils 13w are excited to the S pole. At this time, in the rotor 3, the magnets 341, 343, 345 having the magnetic N pole face the W-phase coils 13w, respectively, and the magnets 342, 344, 346 having the magnetic S pole face the U-phase coils 13u, respectively. At this time, the repulsive force acting on the magnet having the N pole and the repulsive force acting on the magnet having the S pole cancel each other out, so that the rotor 3 does not operate, that is, the stopped state is maintained.

Then, when the rotor 3 is in the first position Ps1, the energization pattern determination portion 81 determines the next V-W pattern as the energization pattern. As a result, the V-phase coils 13v are excited to the N pole and the W-phase coils 13w are excited to the S pole. When the rotor 3 is in the first position Psi, the rotor 3 rotates in the reverse direction (rotates in CW direction) to the sixth position Ps6 (see FIG. 10), where the magnets 341, 343, 345 having the magnetic N pole face the W-phase coils 13w, respectively, and the magnets 342, 344, 346 having the magnetic S pole face the V-phase coils 13v, respectively.

Then, when the rotor 3 is in the sixth position Ps6, the energization pattern determination portion 81 determines the next V-U pattern as the energization pattern. When the rotor 3 is in the sixth position Ps6, the magnets 341, 343, 345 having the magnetic N pole face the U-phase coils 13u, respectively, and the magnets 342, 344, 346 having the magnetic S pole face the V-phase coils 13v, respectively. Hence, even if the energization pattern changes, the rotor 3 does not operate, that is, the stopped state is maintained.

The next W-U pattern is a pattern suitable for activation in the sixth position Ps6. Hence, the rotor 3 rotates in the normal direction (rotates in CCW direction) to the first position Ps1 (see FIG. 5).

That is, when the energization pattern determination portion 81 starts determination from the U-W pattern, an energization pattern suitable for activation in the position is obtained after three determinations of the energization pattern.

(4) V-W pattern

The energization pattern determination portion 81 determines the V-W pattern as the energization pattern. As a result, the V-phase coils 13v are excited to the N pole and the W-phase coils 13w are excited to the S pole. At this time, the rotor 3 rotates in the reverse direction (rotates in CW direction) to the sixth position Ps6 (see FIG. 10), where the magnets 341, 343, 345 having the magnetic N pole face the W-phase coils 13w, respectively, and the magnets 342, 344, 346 having the magnetic S pole face the V-phase coils 13v, respectively.

Then, when the rotor 3 is in the sixth position Ps6, the energization pattern determination portion 81 determines the next V-U pattern as the energization pattern. As a result, the V-phase coils 13v are excited to the N pole and the U-phase coils 13u are excited to the S pole. When the rotor 3 is in the sixth position Ps6, the magnets 341, 343, 345 having the magnetic N pole face the W-phase coils 13w, respectively, and the magnets 342, 344, 346 having the magnetic S pole face the V-phase coils 13v, respectively. Hence, even if the energization pattern changes, the rotor 3 does not operate, that is, the stopped state is maintained.

The next W-U pattern is a pattern suitable for activation in the sixth position Ps6. Hence, the rotor 3 rotates in the normal direction (rotates in CCW direction) to the first position Ps1 (see FIG. 5).

That is, when the energization pattern determination portion 81 starts determination from the V-W pattern, the rotor 3 moves to a position where normal rotation can be performed after two determinations of the energization pattern.

(5) V-U pattern

The energization pattern determination portion 81 determines the V-U pattern as the energization pattern. As a result, the V-phase coils 13v are excited to the N pole and the U- phase coils 13u are excited to the S pole. When the rotor 3 is in the first position Ps1, the rotor 3 rotates in the reverse direction (rotates in CW direction) to the sixth position Ps6 (see FIG. 10), where the magnets 341, 343, 345 having the magnetic N pole face the U-phase coils 13u, respectively, and the magnets 342, 344, 346 having the magnetic S pole face the V-phase coils 13v, respectively.

The next W-U pattern is a pattern suitable for activation in the sixth position Ps6. Hence, the rotor 3 rotates in the normal direction (rotates in CCW direction) to the first position Ps1 (see FIG. 5).

That is, when the energization pattern determination portion 81 starts determination from the V-U pattern, the rotor 3 moves to a position where normal rotation can be performed after a single determination of the energization pattern.

(6) W-U pattern

The energization pattern determination portion 81 determines the W-U pattern as the energization pattern. As a result, the W-phase coils 13w are excited to the N pole and the U-phase coils 13u are excited to the S pole. When the rotor 3 is in the first position Ps1, the magnets 341, 343, 345 having the magnetic N pole face the U-phase coils 13u, respectively, and the magnets 342, 344, 346 having the magnetic S pole face the W-phase coils 13w, respectively. Hence, even if the energization pattern changes, the rotor 3 does not operate, that is, the stopped state is maintained.

The next W-V pattern is an energization pattern suitable for activation in the first position Ps1. Hence, selection of the W-V pattern causes the rotor 3 to rotate in the normal direction (rotate in CCW direction) to the second position Ps2 (see FIG. 6).

That is, when the energization pattern determination portion 81 starts determination from the W-U pattern, the rotor 3 is capable of normal rotation after a single determination of the energization pattern.

As described above, if the rotor 3 is in the first position Ps1, regardless of which one of the six energization patterns is used for activation, a torque required for normal rotation can be generated when an energization pattern is determined after at least three determinations of the energization pattern.

The case where the rotor 3 is in the first position Ps1 has been described. In the brushless motor A, six magnets 34 are arranged at equal angles in the circumferential direction, and nine coils 13 are arranged at equal intervals in the circumferential direction. Accordingly, when the rotor 3 is in any of the second to six positions Ps2 to Ps6, it is just the angle and/or the magnetic poles (N pole and S pole) that is different from when the rotor 3 is in the first position Ps1. Hence, in the brushless motor A, when at least three energization patterns are executed, the subsequent energization pattern becomes an energization pattern suitable for starting in the stop position, regardless of the natural stop position of the rotor 3.

Further, in the brushless motor A, the position of the rotor 3 is not detected. Hence, the energization pattern determination portion 81 cannot grasp the current state of the rotor 3. For example, supply of current to the coils 13u, 13v and 13w may be started, that is, activation may be performed, while the rotor 3 is in a rotating state. In this case, it is possible to stop the rotor 3 by executing any of the six energization patterns. Then, the rotor 3 moves to a position determined by the energization pattern and stops. After the stop, the next energization pattern is an energization pattern suitable for activation at the stop position.

That is, even during rotation of the rotor 3, when the energization pattern is determined at least three times, the energization pattern determined thereafter becomes an energization pattern suitable for activation in the position of the rotor 3.

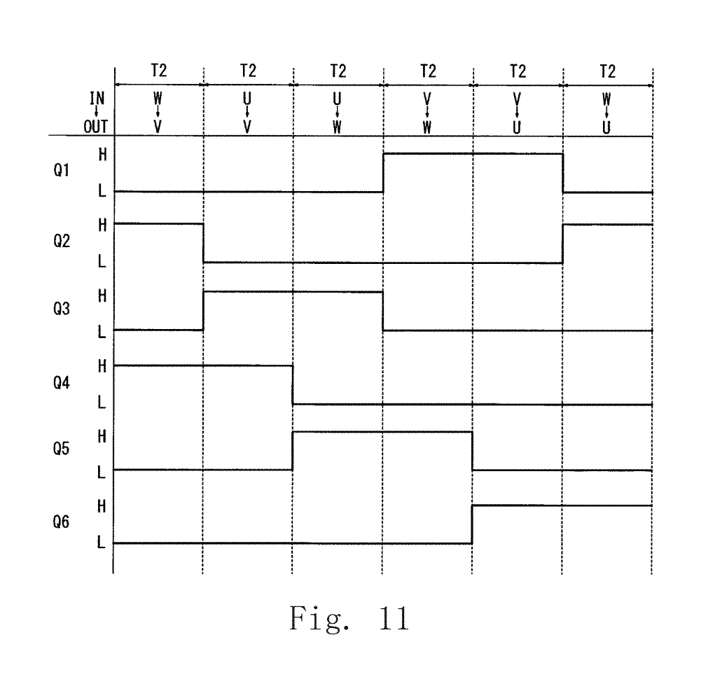

FIG. 11 is a diagram showing input signals and energization patterns of the switching circuit in a second operation mode. For example, when the energization pattern is determined in a state where the rotor 3 is stopped, as described above, reverse rotation or non-rotation may occur depending on the position of the rotor 3 and the determined energization pattern. In the case of reverse rotation, when the next determination of the energization pattern switches the rotation to normal rotation, the direction of torque is reversed. For example, in the case where the energization pattern is switched within the short first energization period T1 as in the first operation mode M1, the direction of torque is reversed in a state where the rotor 3 is rotating by inertial force. Hence, the change of the momentum of the rotor 3 increases, and vibration increases.

For this reason, in the motor controller 8 of the present disclosure, the energization pattern determination portion 81 includes a second operation mode M2 set to a second energization period T2 longer than the first energization period T1 of the first operation mode M1. That is, assuming that an energization period is a time between determination of an energization pattern and determination of the next energization pattern, the energization pattern determination portion 81 includes the first operation mode M1 in which the energization period T1 is determined based on the rotation speed of the rotor 3, and the second operation mode M2 in which the energization period T2 is longer than in the first operation mode M1.

In the first operation mode M1, the rotor 3 is rotated continuously. Hence, the first energization period T1 is a time when the rotor 3 is switched to the next first energization period T1, that is, energization pattern, before stopping at a predetermined position. Accordingly, torque is constantly applied to the rotor 3 in the normal rotation direction (CCW direction). This causes the rotor 3 to rotate continuously.

In the second operation mode T2, the rotor 3 in the stopped state is rotated by energization, and is then stopped in a position determined by the attraction between the coils 13u, 13v, and 13w and the magnet 34. Hence, the second energization period T2 is a time when, in the stopped state of the rotor 3, a current is supplied to the coils 13u, 13v, and 13w to rotate the rotor 3, and then the rotor 3 is stopped in a position determined by the attraction between the coils 13u, 13v and 13w and the magnet 34. Here, the term “stop” includes not only a case where the rotation speed is strictly “0”, but also a case where it is approximately “0”. In other words, it is assumed that a rotation speed at which the momentum of the rotor 3 becomes equal to or less than a predetermined value when the rotational direction changes is included. In the second operation mode M2, the second energization period T2 is constant.

That is, when the energization pattern determination portion 81 operates in the first operation mode Ml, the motor controller 8 performs control to rotate the rotor 3 continuously. In addition, when the energization pattern determination portion 81 operates in the second operation mode M2, the motor controller 8 performs control to temporarily stop the rotor 3 immediately before the second energization period T2 is switched to the next second energization period T2.

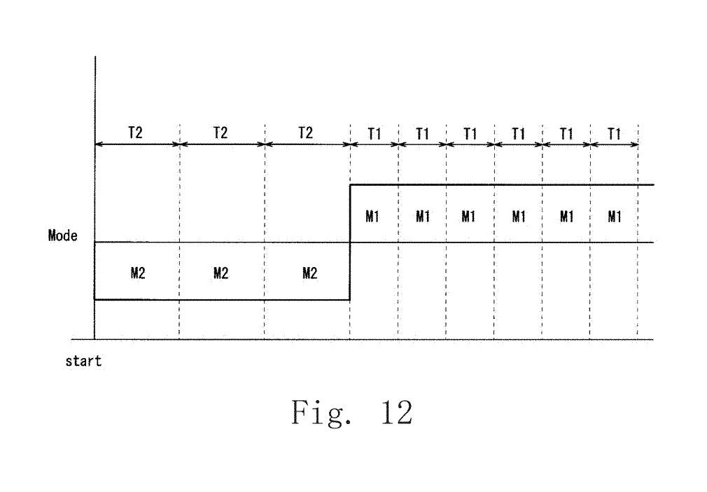

FIG. 12 is a timing chart showing activation of the brushless motor of the present disclosure. As described above, at the time of activation of the rotor 3, the energization pattern determination portion 81 does not acquire the position of the rotor 3. Hence, when the energization pattern is determined, the rotor 3 may rotate reversely. Accordingly, when the rotor 3 is activated, the activation is performed in the second operation mode M2 until the elapse of multiple second energization periods T2, and thereafter, the mode is switched to the first operation mode M1. That is, at the start of activation of the brushless motor A, the energization pattern determination portion 81 passes through multiple energization periods T2 in the second operation mode M2, and then shifts to the first operation mode M1.

When the energization pattern determination portion 81 operates in the second operation mode M2, the rotor 3 is stopped before the switching of the second energization period T2 regardless of whether the rotor 3 is rotated normally or reversely at the time of activation. That is, when the energization pattern determination portion 81 operates in the second operation mode M2, at the start of the second energization period T2, the rotor 3 always starts rotating from a stopped state regardless of the rotation direction of the rotor 3. Since the rotor 3 stops before operation of the next second energization period T2, fluctuation of the momentum of the rotor 3 can be suppressed. Thus, it is possible to reduce vibration generated by switching of the rotation direction of the rotor 3 at the time of activation.

As described above, in the brushless motor A, regardless of the position of the rotor 3, an energization pattern suitable for activation can be set by determining the energization pattern three times in a predetermined order, that is, in the order of rotating the rotor 3 in the normal direction (rotating in CCW direction), from any energization pattern.

Hence, as shown in FIG. 12, the energization pattern determination portion 81 of the example embodiment determines the energization pattern in the second operation mode M2 immediately after the start of activation. Then, the energization pattern determination portion 81 shifts to the first operation mode M1 after the elapse of three second energization periods T2. Thus, since the energization pattern determination portion 81 operates, at the time of activation, in the second energization pattern M2 where the rotor 3 is stopped for each switching of the energization period, vibration due to variation in rotation of the rotor 3 (e.g., normal rotation, reverse rotation, stop) can be suppressed. Note that while the mode is shifted to the first operation mode M1 after the elapse of three second energization periods T2 in FIG. 12, the disclosure is not limited to this. The mode may be shifted to the first operation mode M1 after the elapse of three or more consecutive second energization periods T2 since the start of activation. That is, at the start of activation of the brushless motor A, the pattern determination portion 81 determines the energization pattern at least three times in the second operation mode M2, and then shifts to the first operation mode M1.

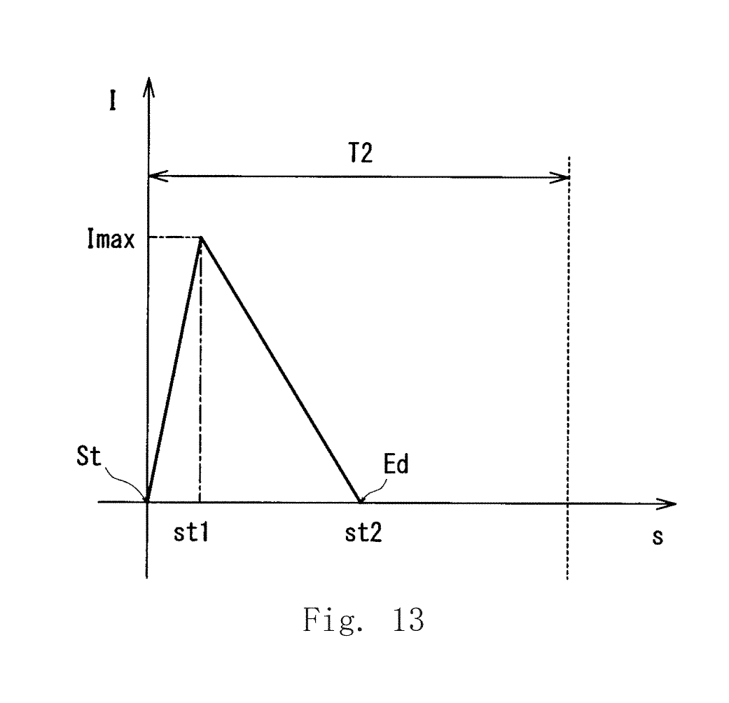

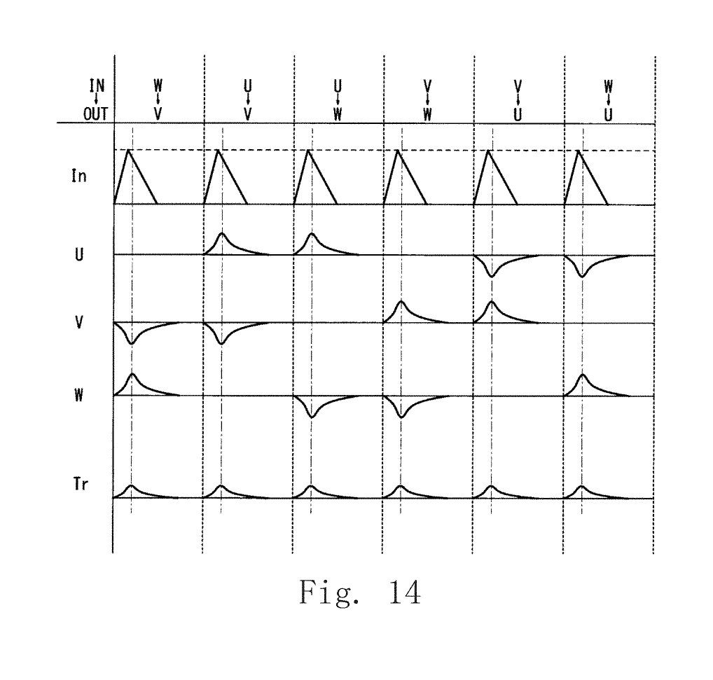

Another example of a motor drive unit of the present disclosure will be described with reference to the drawings. FIG. 13 is a diagram showing a waveform of an input current controlled by a current controller of the motor drive unit of the present disclosure. FIG. 14 is a timing chart showing currents flowing through coils and the torque acting on a rotor when operating at the input voltage shown in FIG. 13. The configuration is the same as that of the motor controller 8 of the first example embodiment except for the waveform of the input current by a current controller 86. For this reason, in this example embodiment, while using the same reference numerals as the first example embodiment for the configuration of a motor controller 8, detailed explanation of the same portion is omitted.

FIG. 14 shows the current flowing through each of coils 13u, 13v, and 13w and the torque acting on a rotor 3 in a second operation mode M2. In FIG. 14, the current flowing through the coils 13u, 13v, and 13w is shown by expressing the current flowing toward a neutral point P1 as positive (“+”) and the current flowing from the neutral point P1 as negative (“−”).

In the diagram shown in FIG. 13, the horizontal axis represents time (s), and the vertical axis represents current (I). As shown in FIG. 13, an input current In from the current controller 86 increases with time from an energization start St, and reaches a maximum value Imax at time st1. Then, the input current In decreases with time from time st1 and reaches an energization end Ed at time st2. Of the input current In, the time (st2−st1) from the maximum value Imax to the energization end Ed is longer than time st1 from the energization start St to the maximum value Imax. In other words, the rate of change of the current from the energization start St to the maximum value Imax is larger than the rate of change of the current from the maximum value Imax to the energization end Ed.

That is, a current supply portion 81 supplies, to the coils 13u, 13v, and 13w, a current having a waveform in which the elapsed time st1 from the energization start St to the maximum value Imax is shorter than the elapsed time (st2−st1) from the maximum value Imax to the energization end Ed.

Additionally, the energization start St and the energization end Ed of the input current In are synchronized with the second energization period T2. That is, in the example embodiment, in the second operation mode M2, the current indicated by the input current In shown in FIG. 13 is supplied in each second energization period T2.

In the brushless motor A, the acting torque changes according to the magnitude of the supplied current. Moreover, in the brushless motor A, the rotor 3 can be moved to the next position by applying a torque larger than the cogging torque to the rotor 3. Accordingly, in the example embodiment, in the second operation mode M2, a torque that can move the rotor 3 to the next position is applied for a short time in the initial stage of the second energization period T2. Thereafter, the rotor 3 is moved to the next position by applying a small torque or by inertial force. Hence, the current controller 86 is controlled to supply the input current In shown in FIG. 13 to the coils 13u, 13v, and 13w.

That is, by operating in the second operation mode M2 of the example embodiment, a torque large enough to move the rotor 3 to the next position is generated in a short time in the initial stage of the second energization period T2. Then, in the remaining time of the second energization period T2, the rotor 3 is rotated by the torque generated by the reduced input current In and the inertial force of the rotation caused by the torque immediately after the start described above.

As described above, the rotor 3 can be moved to the next position even with a small current, by supplying the current to the rotor 3 such that the time from the energization start to the maximum value is shorter than the time from the maximum value to the energization end. That is, the torque applied to the rotor 3 can be reduced. Further, since the maximum torque is applied in a short time, it is possible to suppress the rotation speed of the rotor 3 after application of the maximum torque. Thus, vibration due to switching of the operation of the rotor 3 can be suppressed. Examples of the switching of the operation of the rotor 3 include switching between normal rotation and reverse rotation, and switching between rotation and stop.

In the example embodiment, the torque at the time of activation is reduced by supplying a current having a waveform in which the time from the energization start to the maximum value is shorter than the time from the maximum value to the energization end. Accordingly, power consumption at the time of activation can be reduced. Further, by reducing the torque at the time of activation, it is possible to keep the rotor 3 from moving further than the natural stop position when the rotor 3 moves to the next position. This can suppress circular vibration of the rotor 3 in the rotation direction near the natural stop position. This also can reduce vibration at the time of activation of the brushless motor A.

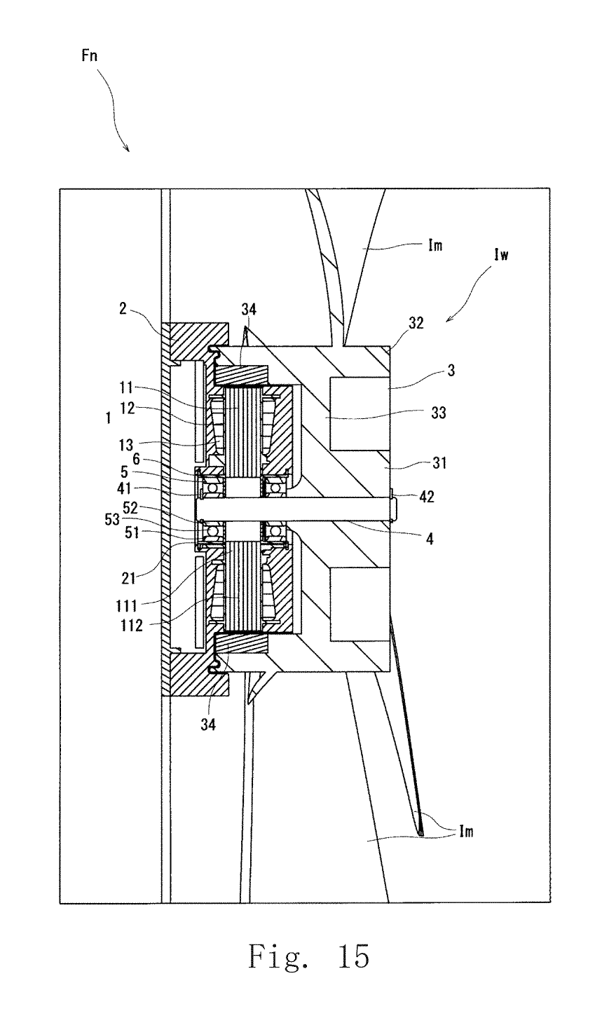

A fan as an example of a device using a brushless motor of the present disclosure will be described with reference to the drawings. FIG. 15 is an enlarged cross-sectional view of a portion of an example of a fan of the present disclosure. FIG. 15 shows an enlarged cross-sectional view of a portion to which a brushless motor A is attached.

A fan Fn includes the brushless motor A. A rotor 3 fixed to a shaft 4 is formed of the same member as an impeller Iw. The fan Fn includes an impeller Im provided on the outer periphery of an outer cylinder 32 of the rotor 3. That is, the fan Fn includes the brushless motor A and the impeller Iw attached to the shaft 4 and rotating with the shaft 4. The impellers Im are arranged at equal intervals in the circumferential direction around the shaft 4. The impeller Im generates an axial air flow as the rotor 3 rotates. Note that the impeller Iw may be configured as a separate member from the rotor 3. At this time, the impeller Iw includes a cup member joined to the rotor 3, and the impeller Im is provided on the outer periphery of the cup member.

The fan Fn may be provided, for example, in a device such as a hair dryer that a user holds during use. By using the brushless motor A of the present disclosure for the fan Fn, it is possible to suppress vibration at the time of activation, and reduce the vibration that the user feels when using the device.

While the example embodiments of the present disclosure have been described above, the example embodiments can be modified in various ways within the scope of the present disclosure.

The present disclosure can be used as a motor for driving a fan provided in a hair dryer or the like.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-10. (canceled)

11. A motor controller that controls rotation of a sensorless brushless motor including a rotor that includes a magnet including magnetic poles, and a stator that includes coils of a plurality of phases, the motor controller comprising:
an energization pattern determiner that determines an energization pattern that specifies a coil to be energized from the coils of a plurality of phases; and
a current supply that supplies a current to the coil based on the energization pattern; wherein
assuming that an energization period is a time from determination of the energization pattern to determination of a next energization pattern, the energization pattern determiner includes:
a first operation mode in which the energization period is determined based on a rotation speed of the rotor; and
a second operation mode in which the energization period is longer than in the first operation mode; and
at a start of activation of the sensorless brushless motor, the energization pattern determiner passes through a plurality of energization periods in the second operation mode, and then shifts to the first operation mode.

12. The motor controller according to claim 11, wherein when the energization pattern determiner operates in the second operation mode, the current supply supplies, to the coil, a current having a waveform in which an elapsed time from an energization start to a maximum value is shorter than an elapsed time from the maximum value to an energization end.

13. The motor controller according to claim 11, wherein the energization period is constant in the second operation mode.

14. The motor controller according to claim 11, wherein at the start of activation of the sensorless brushless motor, the pattern determiner determines the energization pattern at least three times in the second operation mode, and then shifts to the first operation mode.

15. A sensorless brushless motor comprising:
a rotor including a shaft extending along a central axis and a magnet including magnetic poles;
a stator located in a radial direction of the shaft, and holding each of coils of a plurality of phases so as to face the rotor; and
the motor controller according to claim 11.

16. A fan comprising:
the sensorless brushless motor according to claim 15; and
an impeller attached to the shaft and rotatable with the shaft.

17. A motor control method of controlling rotation of a rotor of a sensorless brushless motor including coils of a plurality of phases, the motor control method comprising the steps of:
after determining an energization pattern that specifies a coil to be energized from the coils of a plurality of phases, supplying a current to the coil based on the energization pattern;
determining the energization pattern in any one of a plurality of operation modes including:
assuming that an energization period is a time from determination of the energization pattern to determination of a next energization pattern, a first operation mode in which the energization period is determined based on a rotation speed of the rotor; and
a second operation mode in which the energization period is longer than in the first operation mode; and
at a start of activation of the sensorless brushless motor, determining the energization pattern in the second operation mode in a plurality of the energization periods and then shifting to the first operation mode.

18. The motor control method according to claim 17, wherein when the energization pattern is determined in the second operation mode, a current is supplied to the coil, the current having a waveform in which an elapsed time from an energization start to a maximum value is shorter than an elapsed time from the maximum value to an energization end.

19. The motor control method according to claim 17, wherein when the energization pattern is determined in the second operation mode, the energization period is constant.

20. The motor control method according to claim 17, wherein at the start of activation of the sensorless brushless motor, the energization pattern is determined at least four times in the second operation mode, and then the operation mode shifts to the first operation mode.
